(19) United States
(12) Patent Application Publication
(10) Pub. No.: US 2020/0148247 A1
(43) Pub. Date: May 14, 2020

(54) STEERING WHEEL

(71) Applicant: KABUSHIKI KAISHA TOKAI-RIKA-DENKI-SEISAKUSHO, Aichi-Ken (JP)

(72) Inventors: Yoshiaki MAEKUBO, Aichi (JP); Tamio HARADA, Aichi (JP); Takahiro OHASHI, Aichi (JP); Takahiro FUJII, Aichi (JP)

(21) Appl. No.: 16/067,868

(22) PCT Filed: Jan. 13, 2017
(86) PCT No.: PCT/JP2017/001135

§ 371 Date: Jul. 3, 2018

(30) Foreign Application Priority Data
Jan. 21, 2016 (JP) 2016-010013

(51) Int. Cl. B62D 1/06; B62D 1/10

(52) U.S. Cl. CPC B62D 1/06; B62D 1/10

(57) ABSTRACT

At a rim portion of a steering wheel, a base body is covered by a wood member. Due to a band portion of an engaging hook being installed on a tenon portion, and an anchor pin being inserted in the tenon portion, the engaging hook is anchored by the anchor pin, and the engaging hook is mounted to the wood member. Further, the wood member is mounted to the base body due to the engaging hook being mounted to the base body.

### TECHNICAL FIELD

The present invention relates to a steering wheel that is connected to a steering shaft.

### BACKGROUND ART

In Japanese Patent Application Laid-Open (JP-A) No. 2006-137062, a rim portion metal core is covered by a wood panel, and attaching pins that are fit into a holder of the wood panel are fit-together with engaging holes of spoke portion metal cores, and the wood panel is mounted to the rim portion metal core.

### SUMMARY OF INVENTION

### Technical Problem

By the way, the holder of the wood panel is formed in a substantial box shape, and fit-in holes are formed therein, and the attaching pins can be fit-in. Therefore, in a case in which the holder is made of wood, forming of the holder is difficult, and processing of the wood panel is complex.

The present invention was made in view of the above-described circumstances, and an object thereof is to provide a steering wheel at which the processing of a wood member becoming complex can be suppressed.

### Solution to Problem

In order to achieve the above-described object, a first aspect of the present disclosure comprises: a steering wheel main body that is connected to a steering shaft; a wood member that covers the steering wheel main body; a mounting member that is disposed at the wood member; and an anchor member that stops separation of the mounting member from the wood member, and at which, due to the mounting member being mounted to the steering wheel main body, the wood member is mounted to the steering wheel main body.

In the first aspect of the present disclosure, the wood member is mounted to the steering wheel main body due to the mounting member, at which separation from the wood member is stopped, being mounted to the steering wheel main body. Here, the anchor member stops separation of the mounting member from the wood member. Accordingly, the portion, where the mounting member is disposed, of the wood member can be formed easily, and the processing of the wood member becoming complex can be suppressed.

A second aspect of the present disclosure comprises an anchor portion that is provided at the wood member, and with which the anchor member is engaged, and at which the anchor member anchors the mounting member.

In the second aspect of the present disclosure, the anchor portion, at which the mounting member is anchored by the anchor member, is provided at the wood member. Due thereto, the mounting member can be easily anchored on the wood member.

A third aspect of the present disclosure comprises an insertion hole that is provided at the wood member, and into which the mounting member is inserted, and at which the anchor member is engaged with wood member, and at which the anchor member anchors the inserted mounting member.

In the third aspect of the present disclosure, the mounting member is inserted in the wood member. The insertion hole, at which the inserted mounting member is anchored by the anchor member, is formed in the wood member. Due thereto, the mounting member can be easily anchored on the wood member.

### Advantageous Effects of Invention

In accordance with the present invention, there is the effect that the processing of a wood member becoming complex can be suppressed.

### BRIEF DESCRIPTION OF DRAWINGS

FIG. 1 is a schematic plan view of a steering wheel relating to a first embodiment.

FIG. 2 is an exploded perspective view of a mounting portion relating to the first embodiment.

FIG. 3 is a perspective view of main portions of the mounting portion relating to the first embodiment.

FIG. 4 is a cross-sectional view along line 4-4 of FIG. 1, showing a rim portion relating to a first embodiment.

FIG. 5 is a cross-sectional view, corresponding to FIG. 4, of the rim portion relating to a second embodiment.

FIG. 6 is an exploded perspective view of a mounting portion relating to the second embodiment.

FIG. 7 is a perspective view of main portions of the mounting portion relating to the second embodiment.

FIG. 8 is a cross-sectional view, corresponding to FIG. 5, of the rim portion relating to a third embodiment.

FIG. 9 is an exploded perspective view of a mounting portion relating to a third embodiment.

FIG. 10 is a perspective view of main portions of the mounting portion relating to the third embodiment.

### DESCRIPTION OF EMBODIMENTS

Embodiments of the present invention are described hereinafter with reference to the drawings.

### First Embodiment

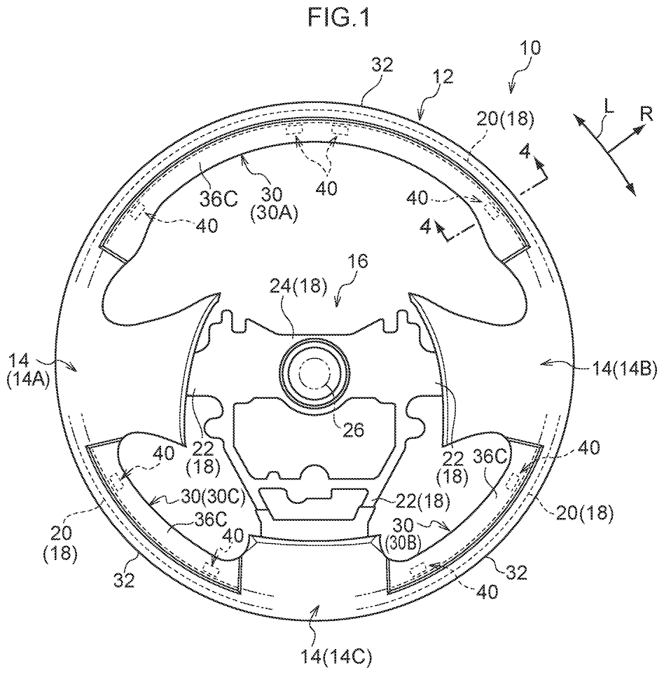

A steering wheel 10 relating to a first embodiment is shown in FIG. 1. The steering wheel 10 is disposed at the vehicle front side of a seat (a driver's seat), in which a vehicle occupant who drives and operates an unillustrated vehicle is seated, and is used in steering by the vehicle occupant. FIG. 1 illustrates the steering wheel 10 as seen in a plan view from the vehicle occupant side.

The steering wheel 10 includes a rim portion 12 that is annular, plural spoke portions 14 that are provided at the rim portion 12, and a boss portion 16 that is provided at the axially central portion of the rim portion 12. Further, the steering wheel 10 has a metal core 18 that is made of metal and forms the frame. The metal core 18 has a rim metal core portion 20 that is disposed within the rim portion 12, spoke metal core portions 22 that are disposed within the spoke portions 14, and a boss metal core portion 24 that is disposed within the boss portion 16. The spoke metal core portions 22 that are connected to the rim metal core portion 20 are connected to the boss metal core portion 24.

At the steering wheel 10, the boss metal core portion 24 of the boss portion 16 that is at the axially central portion is fixed to a steering shaft 26 of the steering device (steering apparatus) of the vehicle, and the rim portion 12 is supported so as to be able to rotate integrally with the steering shaft 26 around the axis of the steering shaft 26. The vehicle is steered due to the vehicle occupant who is seated in the driver's seat grasping the rim portion 12 of the steering wheel 10, and rotatingly operating the rim portion 12 around the axis of the steering shaft 26. Note that FIG. 1 illustrates a straight forward steering position in which the steering wheel 10 is causing the vehicle to travel straight forward. Further, in the following description, the peripheral direction of the steering wheel 10 (the steering wheel peripheral direction) is denoted by arrow L, and the axial direction upper side of the steering wheel 10 (the steering wheel upward direction) is indicated by arrow UP. Further, in the following description, the radially outward direction of the steering wheel 10 (the steering wheel radially outward direction) is exemplified by arrow R.

A wood member (grain portion) 30 that serves as a wood member is provided at the rim portion 12 at the steering wheel 10. At the rim portion 12, as seen from the vehicle occupant side in the straight forward steering position of the steering wheel 10, a spoke portion 14A is provided at the left side, and a spoke portion 14B is provided at the right side, and a spoke portion 14C is provided at the vehicle occupant side, as the spoke portions 14. At the wood member 30, a wood member 30A is provided between the spoke portions 14A, 14B of the rim portion 12, a wood member 30B is provided between the spoke portions 14A, 14C, and a wood member 30C is provided between the spoke portions 14B, 14C. The lengths along the steering wheel peripheral direction of the wood members 30A, 30B, 30C are different, but the basic structures thereof for mounting to the rim portion 12 are similar. In the following description, the wood members 30A, 30B, 30C will be described as the wood member 30 without being differentiated.

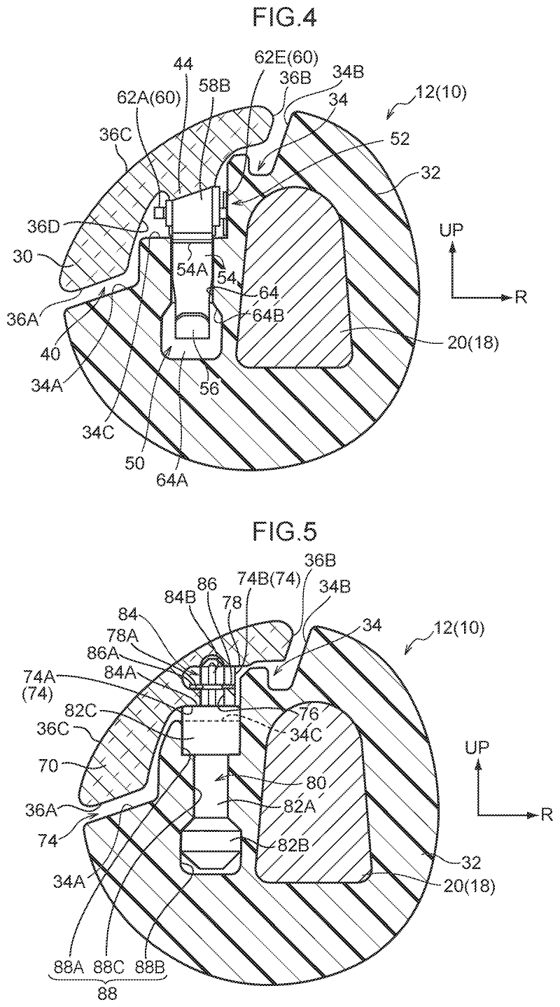

A cross-section of the rim portion 12 cut along the steering wheel radial direction is shown in FIG. 4. The rim portion 12 includes a base body 32 that serves as a steering wheel main body. A resin material such as urethane or the like is used for the base body 32, and the base body 32 is formed by resin molding. The rim metal core portion 20 is accommodated in the base body 32 by insert molding.

As shown in FIG. 1, original stock (pure wood) is used for the wood member 30, and, as seen in a plan view, the wood member 30 is formed in the shape of an arc that runs along the steering wheel peripheral direction. Further, as shown in FIG. 4, the cross-section in the steering wheel radial direction of the wood member 30 is formed in a substantial arc shape by cutting processing, and the wood member 30 faces the base body 32 in a range in the steering wheel upward direction from the steering wheel radially inward direction. Due to the wood member 30 that is formed by using original stock being provided at the steering wheel 10, the texture and warmth, which are distinctive to a wood material and cannot be obtained from a synthetic resin or a sheet-shaped wood material, are obtained.

A step portion 34 is formed at the base body 32 at the region that the wood member 30 faces. The step portion 34 is formed along the steering wheel peripheral direction so as to correspond to the wood member 30. At the step portion 34, a facing surface 34A that faces toward the steering wheel upward direction is formed at the steering wheel radially inward direction side of the base body 32, and a facing surface 34B that faces toward the steering wheel radially inward direction is formed at the steering wheel upward direction side of the base body 32. Further, a facing surface 34C that faces toward the steering wheel upward direction is formed at the step portion 34 at a position that is further toward the steering wheel upward direction side than the facing surface 34A, between the facing surface 34A and the facing surface 34B.

At the wood member 30, a one end portion 36A of the substantially arc-shaped cross-section is the steering wheel radially inward direction side and faces the facing surface 34A of the base body 32, and another end portion 36B is the steering wheel upward direction side and faces the facing portion 34B of the base body 32 and is disposed at the step portion 34 of the base body 32. Due thereto, at the rim portion 12, the step portion 34 of the base body 32 is filled-in by the wood member 30, and the rim metal core portion 20 is covered by the wood member 30 and the base body 32, and the cross-sectional outer shape of the rim portion 12 is substantially circular.

Mounting portions 40 are provided at both end portions in the steering wheel peripheral direction of the wood member 30, and the wood member 30 is mounted and fixed to the base body 32 at the mounting portions 40. Note that, at the wood member 30A whose length along the steering wheel peripheral direction is longer than those of the wood members 30B, 30C, the mounting portion 40 is provided at, in addition to at the both end portions in the steering wheel peripheral direction, one place or plural places at the intermediate portion thereof in the steering wheel peripheral direction, and the wood member 30A is fixed to the rim portion 12 at the respective mounting portions 40.

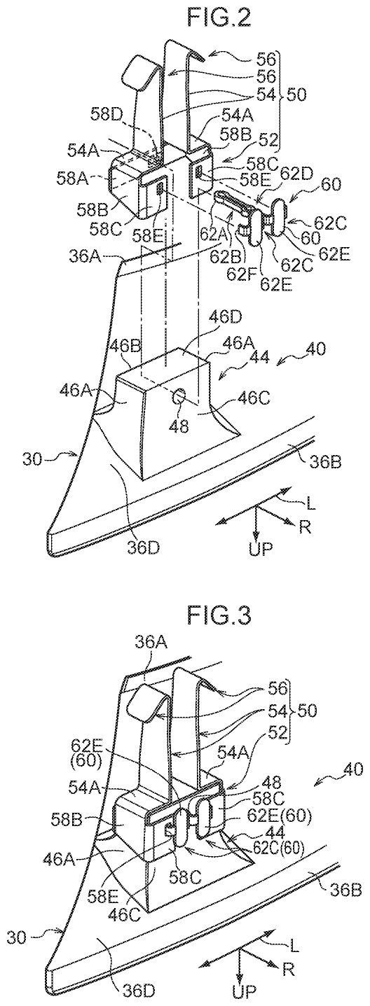

FIG. 2 and FIG. 3 show the base body 32 side surface of the wood member 30 (hereinafter, the surface at the side opposite an obverse 36C, and called reverse surface 36D). At the wood member 30, a tenon portion 44 that serves as an anchor portion is provided at the mounting portion 40 of the reverse surface 36D by cutting processing of the wood material. The tenon portion 44 is shaped as a rectangular block that projects-out from the reverse surface 36D of the wood member 30. A pair of side surfaces 46A (illustration of one of which is omitted in FIG. 2 and FIG. 3) that face one another in the steering wheel peripheral direction, a side surface 46B (illustration omitted in FIG. 2 and FIG. 3, see FIG. 4) that faces toward the steering wheel radially inward direction, a side surface 46C that faces toward the steering wheel radially outward direction, and an end surface 46D that is the projecting direction distal end are provided at the tenon portion 44.

As shown in FIG. 4, when the wood member 30 is made to face the base body 32, the projecting direction of the tenon portion 44 is a direction facing the facing surface 34C of the base body 32, and the end surface 46D faces the facing surface 34C. Further, due to the reverse surface 36D of the wood member 30 being curved in a concave shape, at the tenon portion 44, the projecting height of the side surface 46C that faces toward the steering wheel radially outward direction is greater than that of the side surface 46B that faces toward the steering wheel radially inward direction.

As shown in FIG. 2 and FIG. 4, a through-hole 48 is formed in the tenon portion 44. The through-hole 48 passes-through the tenon portion 44 such that the axial direction runs along the steering wheel radial direction, and the through-hole 48 opens at the side surfaces 46B, 46C respectively.

As shown from FIG. 2 to FIG. 4, at the wood member 30, an engaging hook 50 that serves as a mounting member is installed on the tenon portion 44. The engaging hook 50 is formed by using a metal material such as stainless steel or the like. As shown in FIG. 2, the engaging hook 50 has a band portion 52, leg portions 54, and claw portions 56. The leg portions 54 extend as a pair from the band portion 52, and the claw portions 56 are provided at the respective distal end portions of the leg portions 54. The band portion 52 has a frame plate 58A that faces the side surface 46B of the tenon portion 44, frame plates 58B that are continuous from the both ends of the frame plate 58A and respectively face the side surfaces 46A of the tenon portion 44, and end plates 58C that are continuous from the end portions of the frame plates 58B and face the side surface 46C of the tenon portion 44. The band portion 52 is formed in a substantial frame shape that is rectangular by the frame plate 58A, the pair of frame plates 58B and the pair of end plates 58C.

A rectangular hole 58D, which corresponds to the through-hole 48 that opens at the side surface 46B of the tenon portion 44, is formed in the frame plate 58A at the band portion 52. Further, at the band portion 52, the interval between the end plates 58C is an interval that exposes, between the end plates 58C, the side surface 46C side opening of the through-hole 48 that is formed in the tenon portion 44. Further, long holes 58E are formed in the respective end plates 58C at the band portion 52.

The leg portions 54 are curved in directions of approaching one another from the respective frame plates 58B of the band portion 52, and have proximal portions 54A that face the end surface 46D of the tenon portion 44, and extend as a pair from the distal ends of the proximal portions 54A toward the direction opposite the band portion 52. Further, the width dimensions of the leg portions 54 are narrowed in a step-wise manner such that the claw portions 56 sides thereof are narrower than the band portion 52 sides thereof. The claw portions 56 are bent from the distal end portions of the leg portions 54 in directions of moving away from one another (the steering wheel peripheral direction) that are the outer sides, and the distal ends of the claw portions 56 are directed toward the outer sides of the band portion 52 side, and are inclined so as to form acute angles with respect to the leg portions 54.

The engaging hook 50 is installed on the wood member 30 by the band portion 52 so as to surround the periphery of the tenon portion 44, and the proximal portions 54A of the leg portions 54 face the end surface 46D of the tenon portion 44. Further, the engaging hook 50 that is installed on the wood member 30 exposes the opening of the through-hole 48 of the tenon portion 44 between the pair of end plates 58C and within the rectangular hole 58D that is formed in the frame plate 58A of the band portion 52. With regard to the installing of the engaging hook 50, it is preferable that the engaging hook 50 be installed such that the periphery of the tenon portion 44 is constricted by the band portion 52.

An anchor pin 60 that serves as an anchor member is inserted and disposed in the through-hole 48 of the tenon portion 44. A rod-shaped member, which is made of metal and whose width dimension is narrower than the inner diameter of the through-hole 48 of the tenon portion 44, is used as the anchor pin 60. A ring portion 62A, a shaft portion 62B and wing portions 62C are formed at the anchor pin 60. The ring portion 62A is formed, due to a rod-shaped portion being bent, such that the outer diameter is slightly larger than the inner diameter of the through-hole 48 of the tenon portion 44. The shaft portion 62B is formed by a pair of rod-shaped portions that extend from the ring portion 62A with a predetermined interval therebetween. A widened portion 62D, which is substantially ring-shaped and whose outer diameter is slightly larger than the inner diameter of the through-hole 48 of the tenon portion 44, is formed at the intermediate portion of the shaft portion 62B.

The wing portions 62C are formed by the rod-shaped portions being bent from the distal end portion of the shaft portion 62B in directions of moving away from one another. Long plates 62E, whose length directions are directions intersecting the rod-shaped portions and whose both ends are semicircular, are formed at the respective rod-shaped portions. Further, end portions 62F, which are formed by the rod-shaped portions being bent from the respective distal ends of the wing portions 62C toward the ring portion 62A side so as to become parallel to the shaft portion 62B, are provided at the anchor pin 60.

The ring portion 62A is inserted in the through-hole 48 from the side surface 46C side opening of the tenon portion 44 of the wood member 30, and projects-out from the side surface 46B side opening of the tenon portion 44, and the anchor pin 60 is installed in the tenon portion 44. At the anchor pin 60 that is installed in the tenon portion 44, the shaft portion 62B is disposed within the through-hole 48, and the end portions 62F abut the side surface 46C of the tenon portion 44. Further, with respect to the band portion 52 of the engaging hook 50 that is installed on the tenon portion 44, the ring portion 62A of the anchor pin 60 is inserted within the rectangular hole 58D of the frame plate 58A of the band portion 52, and the end portions 62F are inserted in the long holes 58E that are formed in the end plates 58C of the band portion 52. Due thereto, the engaging hook 50 is engaged with the anchor pin 60. Due to the engaging hook 50 being installed on the tenon portion 44 by the anchor pin 60, the engaging hook 50 is anchored by the anchor pin 60, and movement of the band portion 52 in the direction orthogonal to the axis is stopped by the tenon portion 44, and removal from the tenon portion 44 is stopped.

On the other hand, as shown in FIG. 4, a mounting hole 64 that has a bottom is provided in the base body 32 at the step portion 34 at a position corresponding to the tenon portion 44 of the wood member 30. An unillustrated recessed portion, into which are inserted the tenon portion 44 of the wood member 30 and the band portion 52 of the engaging hook 50 that is installed on the tenon portion 44, is formed in the facing surface 34C of the step portion 34 of the base body 32. The mounting hole 64 is formed from the bottom surface of the recessed portion toward the steering wheel downward direction. Further, at the mounting hole 64, the inner diameter of the opening at the bottom surface of the recessed portion is of a size such that the pair of claw portions 56, whose interval therebetween is narrowed due to the pair of leg portions 54 of the engaging hook 50 being elastically deformed, can be inserted.

Further, a widened portion 64A is provided at the bottom portion side of the mounting hole 64, and inclined surfaces 64B are formed due to the cross-section being widened gradually toward the widened portion 64A. The inner diameter of the cross-section of the widened portion 64A corresponds to the interval between the distal ends of the pair of claw portions 56 in the state in which the elastic deformation of the leg portions 54 of the engaging hook 50 has returned. Due thereto, due to the elastic deformation of the leg portions 54 returning, the distal ends of the claw portions 56 of the engaging hook 50 that is inserted in the mounting hole 64 of the base body 32 abut (not illustrated in FIG. 4) the inclined surfaces 64B, and separation of the engaging hook 50 in the direction of being pulled-out from the mounting hole 64 is impeded.

Mounting of the wood member 30 to the rim portion 12 of the steering wheel 10 is described next as operation of the first embodiment.

The wood member 30 is formed in the shape of an arc that runs along the steering wheel peripheral direction by cutting processing of original stock, and the cross-section of the wood member 30 is formed in an arc shape that runs along the peripheral direction of the rim portion 12. Further, at the time when the reverse surface 36D of the wood member 30 is cut in an arc shape, the tenon portion 44 that is block-shaped is formed, and the through-hole 48 is formed in the tenon portion 44. At this time, due to the reverse surface 36D of the wood member 30 being curved, boring of the through-hole 48 is easy. Accordingly, processing of the wood member 30 from original stock is easy.

The tenon portion 44 of the wood member 30 is inserted in the band portion 52, and the engaging hook 50 is installed at the wood member 30. The engaging hook 50 is installed in a state in which the band portion 52 surrounds the tenon portion 44 of the wood member 30 and constricts the periphery of the tenon portion 44. Further, the anchor pin 60 is inserted and installed in the through-hole 48 at the tenon portion 44 of the wood member 30 at which the engaging hook 50 is installed.

Due to the ring portion 62A being made to face the opening of the through-hole 48 between the end plates 58C of the band portion 52, and the long plates 62E of the wing portions 62C being pushed, the anchor pin 60 is pushed into the through-hole 48 of the tenon portion 44. Further, the anchor pin 60 is pushed-in until the ring portion 62A projects-out at the side surface 46B side of the tenon portion 44 and the end portions 62F abut the side surface 46C of the tenon portion 44. Due thereto, the anchor pin 60 is engaged with the tenon portion 44 in a state in which the widened portion 62D of the shaft portion 62B pushes the inner surface of the through-hole 48 and the tenon portion 44 is sandwiched between the ring portion 62A and the end portions 62F.

In the state in which the anchor pin 60 is engaged with the tenon portion 44, the ring portion 62A is disposed within the rectangular hole 58D of the frame plate 58A of the band portion 52, and the end portions 62F are disposed within the long holes 58E formed at the end plates 58C, and the anchor pin 60 anchors on the band portion 52 of the engaging hook 50. Further, due to the engaging hook 50 being anchored by the anchor pin 60 that is engaged with the tenon portion 44, the engaging hook 50 is obstructed by and fixed to the wood member 30.

Due to the leg portions 54 and the claw portion 56 of the engaging hook 50 being inserted into the mounting hole 64 of the base body 32, the wood member 30 to which the engaging hook 50 is fixed is mounted to the base body 32 of the rim portion 12. The tenon portion 44 of the wood member 30 projects toward the steering wheel downward direction, and the mounting hole 64 of the base body 32 is formed from the facing surface 34C, which faces toward the steering wheel upward direction, toward the steering wheel downward direction. Due thereto, in the state in which the respective claw portions 56 of the plural engaging hooks 50 are made to face the openings of the mounting holes 64, when the wood member 30 is pushed-in in the steering wheel downward direction toward the base body 32, the leg portions 54 are elastically deformed by the claw portions 56 that are inclined with respect to the leg portions 54, and the interval between the claw portions 56 is narrowed, and the engaging hooks 50 enter into the mounting holes 64. Further, at the engaging hooks 50, due to the claw portions 56 that have been inserted in the mounting holes 64 reaching the widened portions 64A, the intervals between the claw portions 56 are widened by the elastic forces of the leg portions 54. Due thereto, the distal ends of the claw portions 56 abut the inclined surfaces 64B of the mounting holes 64, and pulling-out of the engaging hooks 50 from the mounting holes 64 is impeded, and the wood member 30 is mounted and fixed to the base body 32.

Note that, in the fixing of the engaging hook 50 to the base body 32, a time curing agent such as an adhesive or the like may be filled into the mounting hole 64, and may be made to enter-in between the leg portions 54 of the engaging hook 50 that is inserted in the mounting hole 64. Due thereto, due to the adhesive hardening, the pair of leg portions 54 elastically deforming in directions of approaching one another is impeded, and the engaging hook 50 is fixed to the base body 32.

By mounting the wood member 30 to the base body 32 by using the engaging hooks 50 in this way, the wood member 30 can be easily mounted to the base body 32. Further, by mounting the wood member 30 by using the engaging hooks 50, the mounting strength being affected by the adhesive performance of an adhesive is suppressed. Note that an adhesive may be used separately from the engaging hooks 50, and the wood member 30 may be installed at the base body 32 directly or together with the engaging hooks 50.

Note that, in the first embodiment, the tenon portion 44 that is rectangular is formed as the anchor portion, but the shape of the anchor portion is not limited to rectangular, and may be a cylindrical shape, a semicircular shape, a triangular shape, or a polygonal shape that is pentagonal or has more angles than that. It suffices for the band portion 52 of the engaging hook 50 to be formed in the shape of a frame that matches the outer shape of the anchor portion.

### Second Embodiment

A second embodiment is described next. Note that, in the second embodiment, functional parts that are equivalent to those of the first embodiment are denoted by similar reference numerals as in the first embodiment, and detailed description thereof is omitted.

Main portions of the rim portion 12 of the steering wheel 10 relating to the second embodiment are shown in FIG. 5 through FIG. 7. In the second embodiment, a wood member 70 is used instead of the wood member 30 of the first embodiment, and the wood member 70 is mounted to the base body 32 of the rim portion 12. Further, in the second embodiment, mounting portions 72 are provided at the wood member 70 instead of the mounting portions 40.

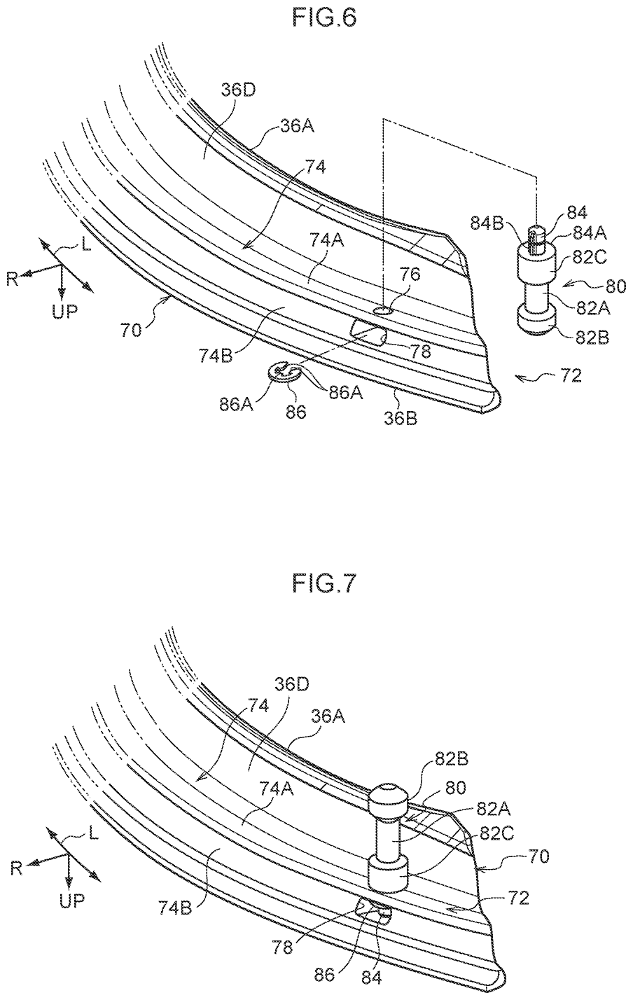

As shown in FIG. 6 and FIG. 7, a projecting portion 74 that serves as an anchor portion is formed at the reverse surface 36D at the wood member 70. The projecting portion 74 is continuous in the steering wheel peripheral direction between the end portion 36A and the end portion 36B at the reverse surface 36D of the wood member 70, and is formed in the shape of a ridge by an end surface 74A that faces toward the steering wheel downward direction and an end surface 74B that faces toward the steering wheel radially outward direction. As shown in FIG. 5, the end surface 74A of the projecting portion 74 that is formed at the wood member 70 faces the facing surface 34C of the step portion 34 of the base body 32.

As shown in FIG. 5 and FIG. 6, an insertion hole 76, which has a bottom and is circular and serves as an insertion hole, is formed in the wood member 70 at the projecting portion 74 at a position corresponding to the mounting portion 72. The insertion hole 76 opens at the end surface 74B of the projecting portion 74, and is bored-in toward the steering wheel upward direction. Further, a communication hole 78 is formed in the wood member 70. The communication hole 78 is bored from the end surface 74A of the projecting portion 74 toward the steering wheel radially inward direction, and traverses the axial direction intermediate portion of the insertion hole 76, and a hole bottom is formed thereat. Due thereto, the communication hole 78 communicates with the insertion hole 76. Further, the communication hole 78 is shaped as an ellipse whose long diameter is in a direction intersecting the axial direction of the insertion hole 76, and the long diameter is made to be greater than the inner diameter of the insertion hole 76. Due thereto, as shown in FIG. 5, the insertion hole 76 opens at an inner surface 78A of the communication hole 78.

As shown from FIG. 5 through FIG. 7, a mounting pin 80 that serves as a mounting member is used at the mounting portion 72 instead of the engaging hook 50. As shown in FIG. 5 and FIG. 6, a synthetic resin material such as ABS or the like is used for the mounting pin 80. Further, a shaft portion 82A that is solid cylindrical, a root portion 82B that is continuous with an axial direction one end side of the shaft portion 82A, and a widened portion 82C that is solid cylindrical and is continuous with the axial direction other end side of the shaft portion 82A are formed at the mounting pin 80. The outer diameter of the axial direction intermediate portion of the root portion 82B of the mounting pin 80 is made to be larger than the outer diameter of the shaft portion 82A. Further, the diameter of the root portion 82B gradually widens from the shaft portion 82A toward the intermediate portion at the axially upper side, and the diameter gradually decreases from the axial direction intermediate portion toward the direction opposite the shaft portion 82A.

Further, at the mounting pin 80, an engaging portion 84 is formed at the end surface of the widened portion 82C, which end surface is at the side opposite the shaft portion 82A. The engaging portion 84 is formed in the shape of a solid cylinder of an outer diameter corresponding to the inner diameter of the insertion hole 76 that is formed in the projecting portion 74 of the wood member 70, and the distal end portion of the engaging portion 84 is rounded. An engaging groove 84A and plural projections 84B are formed at the engaging portion 84. The respective projections 84B project-out outwardly in the radial direction from the peripheral surface of the engaging portion 84, and extend in the axial direction of the engaging portion 84. The engaging groove 84A is formed in the peripheral surface of the engaging portion 84, with the groove direction thereof running along the peripheral direction of the engaging portion 84.

As shown in FIG. 5, at the mounting pin 80, the engaging portion 84 is inserted in the insertion hole 76 until the engaging portion 84 side end surface of the widened portion 82C abuts the end surface 74A of the projecting portion 74. The projections 84B push the inner surface of the insertion hole 76 into which the engaging portion 84 has been inserted. In the state in which the engaging portion 84 is inserted in the insertion hole 76, the engaging groove 84A projects-out slightly from the inner surface 78A of the communication hole 78.

At the mounting pin 80, a stop ring 86 that serves as an anchor member is installed in the engaging groove 84A of the engaging portion 84. As shown in FIG. 6, the stop ring 86 is shaped as an E-type ring (an E-type stop ring) at which a metal material such as steel or the like is used. Plural projecting pieces 86A are formed at the inner peripheral surface of the stop ring 86. The stop ring 86 is inserted from the communication hole 78, and the projecting pieces 86A are fit into the engaging groove 84A of the engaging portion 84 that is inserted in the insertion hole 76 and projects-out into the communication hole 78. At the mounting pin 80, due to the stop ring 86 being fit into the engaging groove 84A of the engaging portion 84 within the communication hole 78, the stop ring 86 abuts the inner surface 78A of the communication hole 78. Due thereto, movement of the mounting pin 80 in the radial direction is stopped by the insertion hole 76, and movement of the mounting pin 80 in the axial direction is stopped by the stop ring 86, and the mounting pin 80 is fixed to the wood member 70. Further, due to the mounting pin 80 being fixed to the wood member 70, the root portion 82B projects from the wood member 70 toward the steering wheel downward direction (the base body 32 direction).

On the other hand, as shown in FIG. 5, a mounting hole 88 is formed in the base body 32 at the facing surface 34C of the step portion 34, at a position corresponding to the mounting portion 72 of the wood member 70. At the mounting hole 88, a recessed portion 88A that corresponds to the widened portion 82C of the mounting pin 80 opens at the facing surface 34C, and an enlarged diameter portion 88B that corresponds to the root portion 82B of the mounting pin 80 is formed at the interior of the base body 32. Further, at the mounting hole 88, the recessed portion 88A and the enlarged diameter portion 88B are communicated by a shaft hole 88C that corresponds to the shaft portion 82A of the mounting pin 80.

At the mounting pin 80 that is fixed to the wood member 70, in the state in which the root portion 82B side end surface is made to correspond to the opening of the shaft hole 88C within the recessed portion 88A of the mounting hole 88, due to the wood member 70 being pushed in the steering wheel downward direction toward the base body 32, the root portion 82B is pushed-in until reaching the enlarged diameter portion 88B, while enlarging the diameter of the shaft hole 88C. Due thereto, the mounting pin 80 is connected and fixed to the base body 32, and the wood member 70, to which the mounting pin 80 is mounted, is fixed to the base body 32.

In this way, at the wood member 70 that is applied to the second embodiment, there is a simple structure in which the projecting portion 74 is formed at the reverse surface 36D, and the insertion hole 76 is formed in the end surface 74A of the projecting portion 74, and the communication hole 78 that communicates with the insertion hole 76 is formed in the end surface 74B. Accordingly, cutting processing of the wood member 70 is easy.

Further, the wood member 70 is fixed to the base body 32 due to the mounting pin 80 being fixed to the wood member 70, and being connected to the base body 32, by the simple structure of the engaging portion 84 being inserted in the insertion hole 76 of the wood member 70 and the stop ring 86 that is inserted from the communication hole 78 being made to engage with the engaging groove 84A of the engaging portion 84. Accordingly, by using the mounting pin 80 in the mounting of the wood member 70 to the base body 32, the mounting strength of the wood member 70 being dependent upon the adhesive performance of an adhesive is suppressed. Note that the mounting of the wood member 70 to the base body 32 may also use an adhesive and not only the mounting pins 80.

Note that, in the second embodiment, the mounting pin 80 is formed of a synthetic resin material, but the mounting pin 80 that serves as a mounting member is not limited to a synthetic resin material, and may be formed by using a wood material or a metal. Further, the mounting hole 88 of the base body 32 that corresponds to the root portion 82B of the mounting pin 80 may be made to be the shape of a groove (the shape of an ellipse) that is open so as to be long in the steering wheel peripheral direction, and an opening, which is at a position that is different than the mounting position of the mounting pin 80, may be widened such that the root portion 82B of the mounting pin 80 can be inserted-in. Due thereto, the installation and fixing of the mounting pin 80 to the base body 32 are possible even if a material that cannot be compressed (elastically deformed) is used for the root portion 82B and the base body 32.

### Third Embodiment

A third embodiment is described next. Note that, in the third embodiment, functional parts that are equivalent to those of the first embodiment or the second embodiment are denoted by similar reference numerals as in the first or second embodiment, and detailed description thereof is omitted.

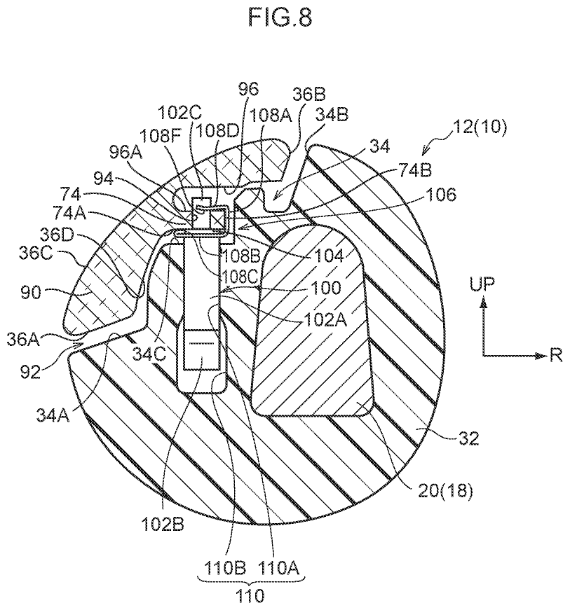

Main portions of the rim portion 12 of the steering wheel 10 relating to the third embodiment are shown from FIG. 8 through FIG. 10. In the third embodiment, a wood member 90 is used instead of the wood member 70 of the second embodiment. The basic structure of the wood member 90 is equivalent to that of the wood member 70, but differs with regard to the point that a mounting portion 92 is provided instead of the mounting portion 72.

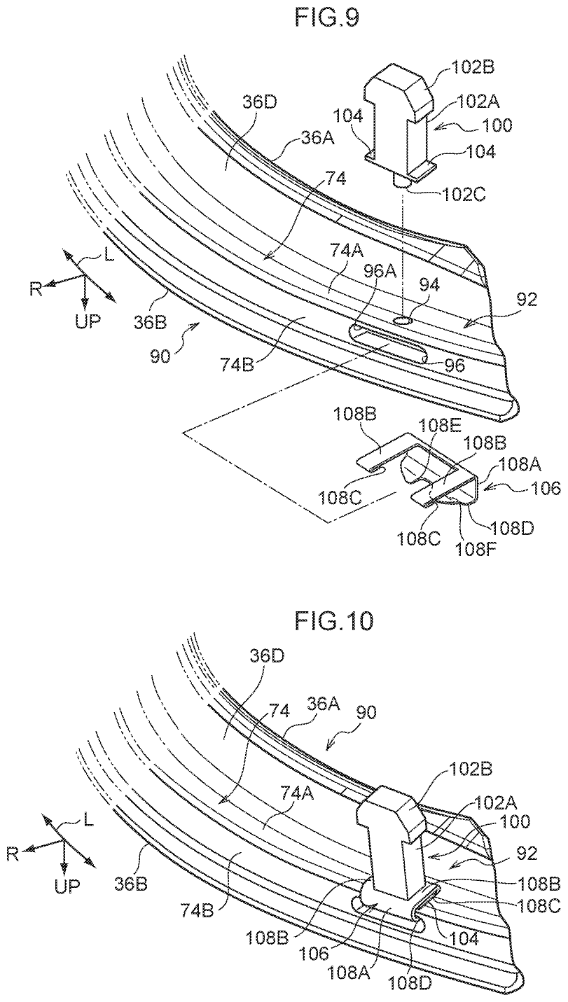

As shown in FIG. 8 and FIG. 9, an insertion hole 94, which has a bottom and is a round hole and serves as an insertion hole, is formed in the wood member 90 at the projecting portion 74 at a position corresponding to the mounting portion 92. The insertion hole 94 opens at the end surface 74B of the projecting portion 74, and is bored-in toward the steering wheel upward direction. Further, as shown from FIG. 8 through FIG. 10, a long hole 96 is formed in the projecting portion 74, at the mounting portion 92 of the wood member 90. The long hole 96 is bored from the end surface 74A of the projecting portion 74 toward the steering wheel radially inward side, and traverses the axial direction intermediate portion of the insertion hole 94, and a hole bottom is formed thereat. Due thereto, the insertion hole 94 opens at an inner surface 96A that is at the end surface 74A side of the long hole 96, and the insertion hole 94 and the long hole 96 are communicated. Further, the opening of the long hole 96 that is formed in the end surface 74B is shaped as an ellipse whose long diameter direction is a direction intersecting the axial direction of the insertion hole 94, and the length direction intermediate portion is rectangular.

A mounting pin 100 that serves as a mounting member is used at the mounting portion 92 instead of the mounting pin 80. A synthetic resin material such as ABS or the like is used for the mounting pin 100. The mounting pin 100 has a shaft portion 102A. A root portion 102B is formed at one end side of the shaft portion 102A, and a pin portion 102C is formed at the other end side of the shaft portion 102A (the side opposite the root portion 102B). Further, flanges 104 are formed at the pin portion 102C side end portion of the shaft portion 102A at the mounting pin 100.

As shown in FIG. 9 and FIG. 10, the cross-section, in a direction intersecting the axial direction, of the shaft portion 102A of the mounting pin 100 is substantially rectangular. The root portion 102B is a substantially trapezoidal shape whose shaft portion 102A side is widened along the steering wheel peripheral direction, and whose width gradually narrows toward the distal end portion at the side opposite the shaft portion 102A. The pin portion 102C is shaped as a solid cylinder, and projects-out from the shaft portion 102A toward the side opposite the root portion 102B. Further, the flanges 104 are rectangular plate-shaped, and project-out as a pair along the steering wheel peripheral direction from the end portion of the shaft portion 102A.

At the mounting pin 100, the pin portion 102C is inserted in the insertion hole 94 of the wood member 90, until the flanges 104 abut the end surface 74A of the projecting portion 74 of the wood member 90. Further, the pin portion 102C that is inserted in the insertion hole 94 projects-out into the long hole 96 from the inner surface 96A of the long hole 96 that communicates with the insertion hole 94. Due thereto, movement of the mounting pin 100 in a direction intersecting the axial direction of the pin portion 102C is stopped by the projecting portion 74.

The mounting pin 100 is installed at the wood member 90 by using a clip 106 that serves as an anchor member. A metal material such as stainless steel or the like is used as the clip 106. As shown in FIG. 9, the clip 106 has a back plate 108A that is shaped as an elongated, substantially rectangular, flat plate. The length in the length direction of the back plate 108A is the distance between the distal ends of the flanges 104 that are formed as a pair at the mounting pin 100. Presser portions 108B are formed as a pair at the back plate 108A at the length direction both ends of one of the long sides. The presser portions 108B are bent at substantial right angles from the back plate 108A, and the distal end portions thereof are bent-back, and end surfaces 108C of the distal ends face the back plate 108A side. Further, the interval between the end surfaces that face one another of the presser portions 108B that are formed as a pair is made to match the width, along the steering wheel peripheral direction, of the shaft portion 102A of the mounting pin 100.

Further, at the clip 106, a tongue piece portion 108D is formed at the other long side of the back plate 108A. The tongue piece portion 108D extends from the long side of the back plate 108A, and the distal end portion outer periphery thereof is substantially arc-shaped. Further, a notch 108E, which is substantially rectangular and that has a notched width that corresponds to the outer diameter of the pin portion 102C of the mounting pin 100 is formed in the distal end portion of the tongue piece portion 108D. The tongue piece portion 108D is bent so as to be at an acute angle with respect to the back plate 108A, and the distal end portion faces the presser portions 108B side, and, at a bent portion 108F, the distal end portion side is bent toward a direction of moving away from the presser portions 108B. Due thereto, the interval between the tongue piece portion 108D of the clip 106 and the presser portions 108B gradually becomes narrow from the back plate 108 side toward the bent portion 108E, and thereafter, the interval gradually widens from the bent portion 108E toward the distal end portion.

In the fixing of the mounting pin 100 to the wood member 90, the shaft portion 102A of the mounting pin 100 that is installed at the wood member 90 is inserted and disposed between the pair of presser portions 108B of the clip 106, and the end surfaces 108C at the distal end portions of the presser portions 108B are made to abut the end surfaces of the flanges 104 (the steering wheel radially inward side end surfaces). Thereafter, while the tongue piece portion 108D of the clip 106 that faces the long hole 96 is elastically deformed, the tongue piece portion 108D is pushed in the long hole 96. Due to the tongue piece portion 108D being pushed into the long hole 96, the pin portion 102C of the mounting pin 100 enters into the notch 108E of the tongue piece portion 108D of the clip 106. Further, due to the tongue piece portion 108D being pushed into the long hole 96, at the tongue piece portion 108D of the clip 106, the bent portion 108F abuts and pushes and urges the inner surface 96A of the long hole 96.

Due thereto, at the mounting pin 100, the flanges 104 and the projecting portion 74 of the wood member 90 are nipped between the presser portions 108B of the clip 106 and the bent portion 108F of the tongue piece portion 108D, and pulling-out of the pin portion 102C from the insertion hole 94 is stopped, and the mounting pin 100 is fixed to the wood member 90. Due to the mounting pin 100 being fixed to the wood member 90, the root portion 102B projects from the wood member 90 toward the steering wheel downward direction (the base body 32 direction).

On the other hand, as shown in FIG. 8, a mounting hole 110 is formed in the base body 32 at the facing surface 34C of the step portion 34, at a position corresponding to the mounting portion 92 of the wood member 90. The mounting hole 110 has a rectangular hole 110A that corresponds to the shaft portion 102A of the mounting pin 100, and an enlarged diameter portion 110B that corresponds to the root portion 102B of the mounting pin 100. The rectangular hole 110A and the enlarged diameter portion 110B communicate with one another. The rectangular hole 110A opens at the facing surface 34C of the step portion 34, and, between the rectangular hole 110A and the enlarged diameter portion 110B, the opening width gradually narrows from the enlarged diameter portion 110B side toward the rectangular hole 110A. Due thereto, an unillustrated inclined surface, which faces the shaft portion 102A side end portion of the root portion 102B of the mounting pin 100, is formed at the mounting hole 110 between the rectangular hole 110A and the enlarged diameter portion 110B.

In a case of fixing the wood member 90 to the base body 32, in the state in which the root portion 102B of the mounting pin 100 that is fixed to the projecting portion 74 is made to face the mounting hole 110, the wood member 90 is pushed toward the steering wheel downward direction toward the base body 32. Due thereto, while the root portion 102B of the mounting pin 100 widens the width of the rectangular hole 110A of the mounting hole 110, the root portion 102B is pushed into the enlarged diameter portion 110B, and pulling-out from the mounting hole 110 is impeded by the unillustrated inclined surface. Due to pulling-out of the root portion 102B from the mounting hole 110 being impeded, the mounting pin 100 is fixed to the base body 32, and the wood member 90 is fixed to the base body 32 via the mounting pin 100.

Accordingly, at the wood member 90, the insertion hole 94, which corresponds to the pin portion 102C of the mounting pin 100, and the long hole 96, which corresponds to the tongue piece portion 108D of the clip 106, are formed in the projecting portion 74. Therefore, the wood member 90 can be fixed to the base body 32 by simple cutting processing. Further, the mounting pin 100 can be fixed to the wood member 90 due to the pair of flanges 104 being formed at the pin portion 102C side of the shaft portion 102A. Moreover, in a case of fixing the mounting pin 100 to the wood member 90 by using the clip 106, there is the simple work of pushing the tongue piece portion 108D into the long hole 96 in a state in which the end surfaces 108C of the presser portions 108B are made to abut the end surfaces of the flanges 104 of the mounting pin 100. Further, by using the mounting pin 100 and the clip 106, the strength of the mounting of the wood member 90 to the base body 32 depending on the adhesive performance of an adhesive is suppressed. Note that the mounting of the wood member 90 to the base body 32 may also use an adhesive and not only the mounting pins 100.

Note that, in the third embodiment, the mounting pin 100 is formed of a synthetic resin material, but the mounting pin 100 that serves as the mounting member is not limited to a synthetic resin material, and may be formed by using a metal. Further, at the mounting pin 100, the cross-sectional shapes of the shaft portion 102A and the root portion 102B are not limited to rectangular, and various types of shapes such as circular or the like may be applied.

Note that, in the first embodiment, the mounting portion 40 that uses the tenon portion 44, the engaging hook 50 and the anchor pin 60 is provided. In the second embodiment, the mounting portion 72 that, by the stop ring 86, engages the mounting pin 80 that is inserted in the insertion hole 76 of the projecting portion 74 is used. In the third embodiment, the mounting portion 92 that anchors, by the clip 106, the mounting pin 100 that is inserted in the insertion hole 94 of the projecting portion 74 is used. However, the present invention is not limited to these. In the mounting of the wood member to the rim portion 12, at least any two of the mounting portion 40, the mounting portion 72 and the mounting portion 92 may be used together. Further, the mounting portion 40, the mounting portion 72 or the mounting portion 92, and a mounting method using an adhesive, may be combined. Namely, the need to carry out complex cutting processing on the wood member is eliminated by using at least one of the mounting portion 40, the mounting portion 72 and the mounting portion 92 in the mounting of the rim portion 12, the spoke portions 14, the boss portion 16 and the like to the steering wheel main body.

Further, in the above-described first embodiment through third embodiment, explanation is given of mounting the wood member to the steering wheel radial direction inward side of the rim portion 12 (a range in the steering wheel upward direction from the steering wheel radially inward direction). However, the position of mounting the wood member is not limited to this. The wood member may be a member that is mounted to an arbitrary position of the outer periphery of the rim portion 12 in a cross-section that runs along the steering wheel radial direction of the rim portion 12, or, may be mounted to the outer periphery of the rim portion 12 by being divided into plural parts. Further, the wood member is not limited to the rim portion 12 that is between the spoke portions 14, and may be mounted to one of the boss portion 16 and the spoke portions 14, or may be mounted so as to span over the rim portion 12 and the spoke portions 14.

The disclosure of Japanese Patent Application No. 2016-010013 that was filed on Jan. 21, 2016 is, in its entirety, incorporated by reference into the present specification.

1. A steering wheel comprising:
a steering wheel main body that is connected to a steering shaft;
a wood member that covers the steering wheel main body;
a mounting member that is disposed at the wood member; and
an anchor member that stops separation of the mounting member from the wood member, and at which, due to the mounting member being mounted to the steering wheel main body, the wood member is mounted to the steering wheel main body.

2. The steering wheel of claim 1, further comprising an anchor portion that is provided at the wood member, with which the anchor member is engaged, and at which the anchor member anchors the mounting member.

3. The steering wheel of claim 1, further comprising an insertion hole that is provided at the wood member, into which the mounting member is inserted, and at which the anchor member is engaged with wood member, and at which the anchor member anchors the inserted mounting member.

4. The steering wheel of claim 2, wherein:
the anchor portion is a tenon portion; and
the tenon portion is a block shape that is rectangular and that projects-out from a reverse surface of the wood member.

5. The steering wheel of claim 1, wherein the mounting member is an engaging hook that is made of metal.

6. The steering wheel of claim 2, wherein the anchor portion is a projecting portion, and the projecting portion is continuous in the steering wheel peripheral direction at a reverse surface of the wood member, and is formed in a shape of a ridge.
